(19) United States
(12) Patent Application Publication
(10) Pub. No.: US 2009/0147935 A1
(43) Pub. Date: Jun. 11, 2009

(54) PHONE MANAGING METHOD FOR ELECTRONIC COMMUNICATION DEVICE

(76) Inventors: Yuan Li, Nanjing (CN); Qiang Fan, Nanjing (CN)

Correspondence Address: Muncy, Geissler, Olds & Lowe, PLLC, P.O. BOX 1364, FAIRFAX, VA, 22038-1364, US

(21) Appl. No.: 12/331,910

(22) Filed: Dec. 10, 2008

(30) Foreign Application Priority Data
Dec. 11, 2007 (TW) 096147289

(51) Int. Cl. H04M 1/56

(52) U.S. Cl. 379/142.06

(57) ABSTRACT

A phone managing method is implemented within an electronic communication device installed with a location system and having several preset regions stored with sorted received calls in different groups. The managing method includes the steps of (a) receiving a communication signal so that a phone number corresponding to the communication signal is obtained; (b) detecting the location of the electronic communication device receiving the communication signal; (c) comparing the phone number with the received calls in the preset regions; and (d) rejecting the phone number in case the phone number is excluded from anyone of the received calls in the preset regions.

This application claims the benefit of the Taiwan Patent Application Serial NO. 096147289, filed on Dec. 11, 2007, the subject matter of which is incorporated herein by reference.

### BACKGROUND OF THE INVENTION

1. Field of the Invention

The present invention relates to a phone managing method, more particularly to a phone managing method to be implemented in an electronic communication device that uses a locating system to detect the location of an incoming call so as to filtering out an unwanted incoming call and the method thereof.

2. Description of the Prior Art

Due to the economic development and progress in the communication field, a mobile phone becomes an indispensible article in our daily life so that each person has at least one mobile phone in possession. Since it is convenient to be carried along with the user, the communicate system between the parties concerned is shifted from the lined phone in a room to an outdoor environment.

So far, the mobile phone of lately has developed to possess multi-functions. The latest mobile phone is equipped with filtering or guarding ability to prevent the mobile phone from receiving unwanted calls. When the incoming call belongs to an undesired list consisting of a plurality of unwelcome phone numbers, the communication is disconnected immediately or the incoming call is diverted to a voicemail box (depending of the manufacturer's arrangement) or the incoming call is filtered out directly.

However, the abovementioned filtering way is sometimes not beneficial to the user. For instance, when a person returns home from the office at the end of a working day, in order to have privacy he can set phone numbers of the boss and the office staff into a rejected list so that his mobile phone will not be activated upon receipt of those calls. The next day, if he fails to set the mobile phone back to its normal condition (i.e. permitting the mobile phone to receive calls from the office staff), he would not be able to carry on or accomplish his responsibility dutifully.

The prior art phone managing method is somewhat rough and therefore the user is unable to set the mobile phone to reject calls coming from different regions. Therefore, the present invention is to provide a new design or plans to solve the problems encountered in the prior art.

### SUMMARY OF THE INVENTION

The object of the present invention is to provide a phone managing method for use in an electronic communication device that uses a location system to detect the location of the incoming call and compare the incoming call with respect to a received call list. If the incoming call is excluded from the received call list, the incoming call is filtered out so as to be stored within a missed call list of the electronic communication device. The corresponding time is also recorded meanwhile.

In order to achieve the above mentioned object, the phone managing method of the present invention is implemented in an electronic communication device installed with a location system and having a plurality of preset regions stored with sorted received call in different groups. The phone managing method includes the following steps (a) receiving a communication signal so that a phone number corresponding to the communication signal is obtained; (b) locating a region of the electronic communication device; (c) comparing the phone number with the received calls in the preset regions; and (d) rejecting the phone number in case the phone number is excluded from anyone of the received calls in the preset regions. The phone number is filtered out and the rejected phone number is stored within a missed call list.

The phone managing method further includes the steps of: checking out whether the communication signal is received within a predetermined time period or not upon confirming that the phone number matches with one of the received calls in the preset regions; switching the electronic communication device to a talking mode upon confirming that the communication signal is received within the predetermined time period; and switching the electronic communication device to a suspending mode upon confirming that the communication signal is not received within the predetermined time period.

The electronic communication device includes a communication catalog consisting of the received call list and the missed call list.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 is a block diagram illustrating steps of a phone managing method of the present invention; and

FIGS. 2A to 2E respectively illustrate a screen display of an electronic communication device, which uses the phone managing method of the present invention.

### DETAILED DESCRIPTIONS OF THE PREFERRED EMBODIMENTS

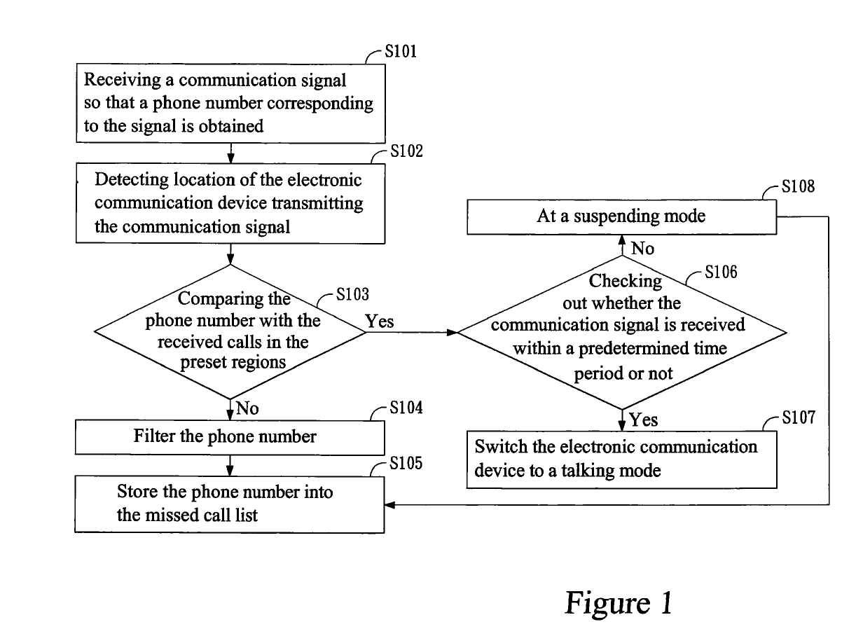

FIG. 1 is a block diagram illustrating steps of a phone managing method of the present invention. The phone managing method of the present invention is implemented in an electronic communication device installed with a location system and having guarding ability, such as rejecting an unwanted call. The electronic communication device can be a mobile phone, an IP phone or other phones of different types; no restriction should be limited thereto.

In one embodiment, the electronic communication device installed with the phone managing method of the present invention is switched on to a suspending mode, and all the function keys in ready. The electronic communication device has a phone directory consisting of a plurality of preset regions stored with sorted received calls in different groups. When the electronic communication device receives a communication signal (an incoming call), a phone number corresponding to the communication signal is obtained (S101). The location system of the electronic device will detect the location of the electronic communication device transmitting the communication signal (S102). Afterward, the phone number is compared with the sorted received calls in the preset regions (S103).

To those skilled in the art, the communication signal can be a wireless signal dialed from a mobile phone or a lined phone. Upon checking that the phone number excluded from anyone of the received calls in the preset regions, the phone number is rejected, i.e. the phone number is filtered out (S104). The filtering process or ability includes the electronic communicated device is vibrated to remind the user of the incoming call, the incoming call is disrupted (such as diverted to the voicemail box), or a replied message is transmitted (such as engaged, in conference, unavailable presently) to the caller. After the incoming call is filtered out and if the incoming call is one of unwanted phone numbers, the incoming call is rejected and the rejected phone number is stored within a missed call list in the electronic communication device (S105).

The phone numbers in the missed call list are arranged according to a time schedule such that the missed call list will display names of the callers (personal names of company's name) and the date and time of calling, In case, the phone number of the incoming call is not shown in a received call list, of the phone directory, the phone number of the incoming call will be displayed in the missed call list.

Return to the step (S103). Upon confirming that the phone number matches with one of the received calls in the preset regions, it indicates that the phone number is a welcome ones and the user of the electronic communication device wishes to accept the incoming call. At this time, the device vibrates or gives out alarm sound or lighting to remind the user to check out whether the communication signal is received within a predetermined time period or not (S106). For receiving the communication signal, the user must press an accept key or a predetermined button in the device to respond confirmation of the predetermined time period.

In this embodiment, the predetermined time period can be set by the manufacturers or by the user himself.

Upon confirming that the communication signal is received within the predetermined time period, the electronic communication device is switched to a talking mode, i.e., the user can talk with the caller over the mobile phone meanwhile the phone number of the incoming call is recorded in the received call list (S107).

On the other hand, upon confirming that the communication signal is not received within the predetermined time period, then the electronic communication device is switched to a suspending mode meanwhile the message is displayed in the screen display of the device and the phone number corresponding to the message is recorded in the missed call list (S108).

In the present embodiment, the electronic communication device includes a communication catalog consisting of the received call list and the missed call list.

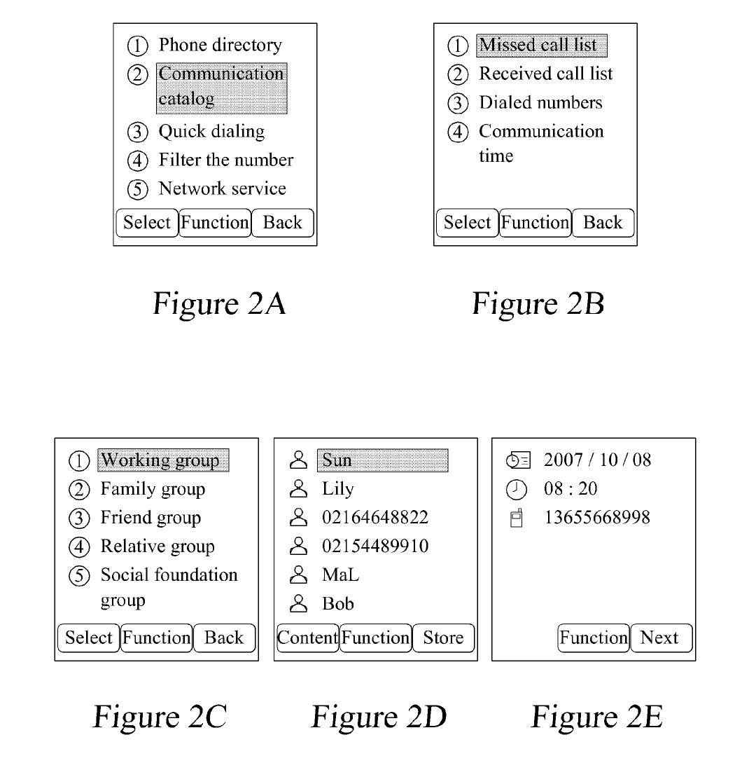

FIGS. 2A to 2E respectively illustrate a screen display of the electronic communication device installed with the phone managing method of the present invention.

FIG. 2A illustrates the screen display of the electronic communication device in the suspending mode, wherein the screen display includes (1) a phone directory; (2) a communication catalog; (3) hot dialing numbers; (4) phone guard and (5) network service.

When the “communication catalog” is selected as shown in FIG. 2B, the screen display of the electronic communication illustrates the following items (1) missed call list; (2) received call list; (3) dialed numbers; and (4) communication time. FIG. 2C represents the screen display if you select and enter the missed call list.

The missed call list includes phone numbers of (1) working group; (2) family group; (3) friend group; (4) relative group; and (5) social foundation group. The screen display simultaneously shows a function menu including the function keys (1) setting; (2) edit; (3) add new file; (4) delete this item; (5) delete all; and (6) back to function menu. For instance, in the working group, the user can select the setting function to set the location system to detect the location of the incoming call from company or office. Later, he can set the phone number of the aforesaid company into the received call list for future use.

FIG. 2D represents the screen display if you select the working group, which consists of 6 names or phone numbers of missed calls. The screen display simultaneously shows a function menu including the function keys (1) edit; (2) filter the call; (3) delete; (4) delete all; (5) add new title; and (6) back to main menu, wherein the edit key is used for editing names and phone numbers of the callers and the filter key is used for diverting the incoming call to the filter process while add new title key is to edit a title for the incoming call.

FIG. 2E shows the screen display of the electronic communication device if you select one content and press the confirm key. The content includes the date of the incoming call 2007/10/08; time of calling (08:20) and the phone number 13655668998. Within the screen display, the user can edit the name, filter the phone number, delete or store the phone number into the received call list, add new title or return to the main menu.

From the aforesaid explanation, it is obviously clear that with the phone managing method of the present invention, the user can easily find out by filtering the incoming call, the phone number and the calling time and date.

An important to note that the user can re-set the filtered the phone number to be filtered again upon the next incoming call, dial back to the filtered phone number, send a message back to the filtered phone number, stored the filtered phone number in the missed call list according to the user desired.

In this embodiment, when the incoming call is diverted to the filtering function and after the filtering process, the user can know the time of the incoming call and the number of calling.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A phone managing method for use in an electronic communication device installed with a location system and having a plurality of preset regions stored with sorted received calls in different groups, comprising:
(I) receiving a communication signal so that a phone number corresponding to said communication signal is obtained;
(II) detecting a location of the electronic communication device receiving said communication signal;
(III) comparing said phone number with the sorted received calls in the preset regions; and
(IV) rejecting said phone number in case said phone number is excluded from anyone of the received calls in the preset regions.

2. The phone managing method according to claim 1, wherein said rejected phone number is being stored within a missed call list.

3. The phone managing method according to claim 1, further comprising the steps of:
(V) upon confirming that said phone number matches with one of said received calls in the preset regions, checking out whether said communication signal is received within a predetermined time period or not;
(VI) switching the electronic communication device to a talking mode upon confirming that said communication signal is received within said predetermined time period; and
(VII) switching the electronic communication device to a suspending mode upon confirming that said communication signal is not received within said predetermined time period, wherein the phone number corresponding to said communication signal is not received is a denied phone number.

4. The phone managing method according to claim 3, wherein when the electronic communication device is switched into said talking mode, said phone number is being stored within a received call list.

5. The phone managing method according to claim 3, wherein when the electronic communication device is switched into said suspending mode, said denied phone number is being stored within a missed call list.

6. The phone managing method according to claim 2 wherein the electronic communication device includes a communication catalog consisting of said missed call list.

7. The phone managing method according to claim 4, wherein the electronic communication device includes a communication catalog consisting of said received call list.

8. The phone managing method according to claim 5, wherein the electronic communication device includes a communication catalog consisting of said missed call list.

9. The phone managing method according to claim 5, wherein said missed call list includes a plurality of names corresponding to said phone numbers.

10. The phone managing method according to claim 1, wherein the electronic communication device includes a phone directory consisting of the preset regions stored with the sorted received calls in different groups.
